(19) United States
(12) Patent Application Publication
(10) Pub. No.: US 2024/0046190 A1
(43) Pub. Date: Feb. 8, 2024

(54) COMPUTER-IMPLEMENTED MONITORING METHODS AND SYSTEMS FOR A RENEWABLES PLANT

(71) Applicant: Topsoe A/S, Kgs. Lyngby (DK)

(72) Inventors: Fie Alice Hallkvist WILBEK, Gentofte (DK); Henrik Wolthers RASMUSSEN, Friendswood, TX (US); Anders Erik BOJSEN, Höllviken (DK); Liv HOVGAARD, Vedbaek (DK); Thor GALLARDO, Houston, TX (US); Sylvain VERDIER, Copenhagen (DK); Ole Frej ALKILDE, Valby (DK); Priyesh THAKKER, Missouri City, TX (US); Mathias Bøje MADSEN, Kgs. Lyngby (DK)

(73) Assignee: Topsoe A/S, Kgs. Lyngby (DK)

(21) Appl. No.: 18/258,966

(22) PCT Filed: Dec. 21, 2021
(86) PCT No.: PCT/EP2021/087238

§ 371 Date: Jun. 22, 2023

Related U.S. Application Data
(60) Provisional application No. 63/130,181, filed on Dec. 23, 2020.
(60) Provisional application No. 63/136,049, filed on Jan. 11, 2021.

(51) Int. Cl. G06Q 10/0639; G06Q 10/0637

(52) U.S. Cl. CPC G06Q 10/06393; G06Q 10/0637

(57) ABSTRACT

The disclosure relates to a computer-implemented monitoring method for a renewables plant, the plant being configured for production of a chemical or fuel product at least partly from a renewable feedstock or source, the plant comprising a plurality of means for registering parameters of the production process, preferably a plurality of sensors in the plant, e.g., along a reactor. The method further comprises calculating a sustainability score from the received sensor data. The disclosure further relates to a computer-implemented monitoring method and system, a data-processing system and a renewables plant comprising the above.

### FIELD

The disclosure concerns production of renewable fuels and chemicals, in particular monitoring and optimizing the production and environmental footprint thereof.

### BACKGROUND

There is a growing interest in producing chemicals and fuels, such as ammonia, methanol, ethanol, naphtha, jet fuel, diesel, etc., from renewable feedstocks or sources, so-called renewable chemicals, including e-chemicals and fuels, including e-fuels.

The consumers, investors and governments/legislators are focusing on more sustainable solutions for many of the chemical, petrochemical and refining processes worldwide. This puts a pressure on the industry towards lowering their environmental impact. In order to quantify the environmental impact of chemicals and fuels production, a number of different methods have been developed, as e.g. Life Cycle Analysis (LCA), Carbon Intensity (CI), Green House Gas (GHG) emission, or other ways of measuring carbon footprint, e.g. similarly suitable sustainability scores.

One of the potential routes to contribute to the transition is the concept of e-fuels (also mentioned in the literature as Electrofuels or Synthetic Fuels or Power to X (PtX) (Power to Gas (PtG)/Power to Liquid (PtL)). The e-fuels production route combines, in an energy-intensive process, “green” hydrogen produced by the electrolysis of water, using green hydrogen with CO₂ captured either from a concentrated source (flue gases from an industrial site, for example) or from the air (Air Capture technologies). Green hydrogen is typically defined as hydrogen produced from renewable energy, i.e., extracted from water using electrolysis and green electricity. The CO₂ capture is not from the hydrogen production but from another source. Green hydrogen can also be called e-hydrogen.

E-fuels can be obtained with a very low Green House Gases (GHG) intensity offering one plausible option to effectively contribute to reduce GHG emissions across different transport sectors, and allowing renewable electricity to be ‘stored’ in liquid and gaseous (e-)fuels.

Therefore, it would be advantageous to obtain a method for monitoring and optimizing a sustainability score of a renewable fuel or chemical production, particularly said method being automated and minimizing or eliminating time gaps elapsing from the collection of the data and calculation of optimal plant parameters.

Furthermore, it would be advantageous to monitor and optimize a utilization factor such as the product yield in said plants. An additional advantage would arise from the operation of the unit by letting the system control and adjust the plant, through a closed loop control.

There is also a significant legislative push to include more renewable fuels mixed into fossil fuels, e.g., for transportation, and for monitoring the environmental impact of such fuels. When using the system of the present disclosure to comply with documentation requirements, sustainability scores are continuously calculated and stored and the user can document the GHG emissions to relevant authorities on demand.

To incentivize the shift towards fuels with a higher content of renewable components, legislation on the level of CI score, GHG emission factor, or similar sustainability scores of renewable fuels are being employed. Hence, for the production of renewable fuels continuous or frequent monitoring of the sustainability scores can also be utilized for optimization of profit.

### BRIEF DESCRIPTION OF DRAWINGS

In the following details of embodiments of the disclosure will be illustrated by the attached drawings, in which

FIG. 1 is a flow-chart illustrating an exemplary embodiment of a computer-implemented monitoring method,

FIG. 2 is a flow-chart illustrating another exemplary embodiment of a computer-implemented monitoring method,

FIG. 3 illustrates an exemplary embodiment of a monitoring system according to the disclosure,

FIG. 4 shows another exemplary embodiment of a monitoring system,

FIG. 5 shows an example of a renewable fuel plant, illustrating different parameters of production, and

FIG. 6 shows an example of a hydrogen production plant, illustrating different parameters of production.

FIG. 7 is a block diagram illustrating an exemplary configuration of a computing device.

### DEFINITIONS

Blue hydrogen is typically produced from fossil sources such as natural gas or coal, with carbon capture and storage (CCS) technology. In this case, the emitted CO₂ is captured and stored (CCS).

Carbon Intensity or Carbon Intensity Score One of the key performance indicators (KPI) that organizations are focusing on to determine their environmental effect is Carbon Intensity Scores. A Carbon Intensity Score, or CI Score, is a life cycle measurement of all total hydrocarbons, or greenhouse gas emitted, versus e.g. the amount of energy consumed. The CI value is typically used in United States of America and other countries in the Greenhouse Gases, Regulated Emissions and Energy Use in Transportation (GREET) Model and is calculated by compiling all the carbon emitted along the supply chain for that fuel including all the carbon used to (where applicable) explore, mine, collect, produce, transport, distribute, dispense and burn the fuel, however there are other calculation modes for the CI score. Lower CI scores are most favorable because they are the cleanest solutions.

Catalytic reaction or step is a process where chemical reaction rates are altered by the addition of a catalyst, that is not itself changed during the chemical reaction. A method of the present disclosure comprises receiving sensor data for temperature and pressure in the catalytic reaction step.

Closed loop system: System to measure, monitor, and control a process and one way in which to accurately control the process is by monitoring its output and “feeding” some of it back to compare the actual output with the desired output so as to reduce the error and if disturbed, bringing the output of the system back to the original or desired response. There may be one or more feedback loops or paths between its output and its input.

Composition means the identity of the components of a mixture, such as feedstock or other information about a certain composition may be provided as standard, batch related or regulated data but also may be assessed and/or monitored by use of sensors or predicted by a computer model, such as a software application predicting the composition at different stages of production (underlying variables) or retrieved by analyzing collected samples in a laboratory and storing them in an accessible database. Said sensor-based assessment may also be performed at any stage during operation in a plant, as well as with various intervals between measurements.

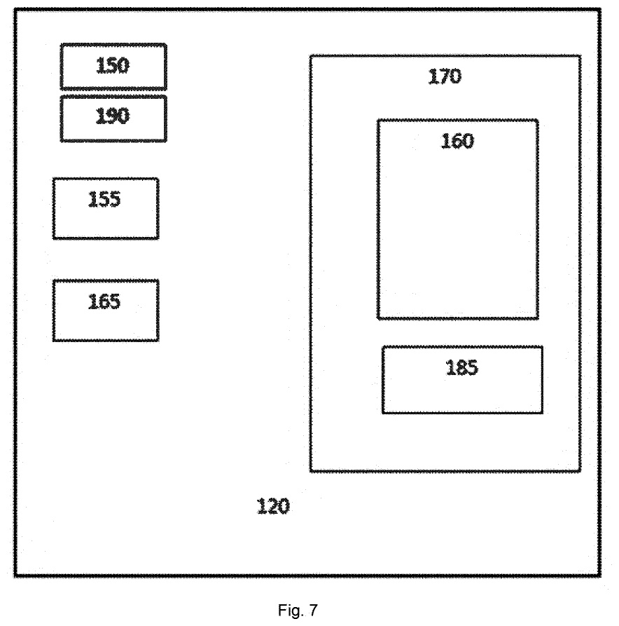

A computer-implemented method or system involves the use of a computer, computer network or other programmable apparatus, where one or more features are realised wholly or partly by means of a computer program. Illustrative embodiments of computer-implemented methods and systems are shown on FIG. 7.

Data cleansing within the context of the present disclosure means outlier detection/removal, low-pass filter, and steady-state detection. Data cleansing may be performed as part of the measurements of the individual sensors, when combining sensor data from one or more sensors, or as the input data is received for calculating the sustainability score. Data cleansing can also comprise reconciliation, where the measured data are corrected to ensure that the overall plant mass and energy balance is fulfilled.

Data reconciliation within the context of the present disclosure means correcting the input data to ensure overall mass energy and component balances are fulfilled.

Deviation in measured data (115, 215, 415, 515) is a result of a variation in an underlying variable or parameter. To identify a deviation, the observed current status (230, 430, 530) and the desired or expected status (240, 440, 540) is compared. When it has been established which change in the underlying variables cause a deviation in the observed measured (e.g., sensor) data and thus in the calculated sustainability score, opposing changes may be made in these underlying parameters so as to realize the expected or desired sustainability score.

E-chemicals may be comprised by “power-to-X” or e-fuels, power-to-liquids or synthetic fuels. An e-chemical is a chemical such as, e.g., ammonia or methanol produced from renewable energy. For example, e-methanol can be produced from waste streams, electrolysis hydrogen, and CO₂ capture. E-chemicals may be defined as synthetic chemicals resulting from the combination of green or e-hydrogen produced by electrolysis of water with renewable electricity and CO₂ captured either from a concentrated source or from the air.

Environmental footprint means the effect or impact that a company, activity, plant, unit, etc. has on the environment, e.g., the amount of natural resources that they use and the amount of harmful gases (emission) that they produce.

Feedstock is used here to signify a type of renewable biomass or waste that is converted into a renewable fuel or chemical product. Oxygenates are a preferred category of renewable feedstocks which typically comprise one or more oxygenates taken from the group consisting of triglycerides, fatty acids, resin acids, ketones, aldehydes or alcohols where said oxygenates originate from one or more of a biological source and a thermal and/or catalytic degradation process, including a gasification process or a pyrolysis process, such that a wide range of feedstocks, especially of renewable origin may be converted into hydrocarbon. This includes feedstocks originating from plants, algae, animals, fish, vegetable oil refining, other biological sources, domestic waste incl. plastic waste and end of life tires, industrial biological waste like tall oil or black liquor as well as non-biological waste comprising suitable compositions, such as plastic fractions, typically after a thermal and/or catalytic degradation process. Further examples of renewable feedstocks are: Corn starch, soybean oil, switchgrass, rapeseed oil, tall oil, used cooking oil and landfill biogas, among several others. When multiple feedstocks are comingled and converted to renewable fuel together (even though each could be processed independently to make the same type of fuel, for example corn starch and grain sorghum starch processed at the same time to make ethanol), the United States Environmental Protection Agency (EPA) evaluates these feedstocks separately when calculating the lifecycle greenhouse gas emissions for a fuel pathway.

Green Hydrogen is typically defined as hydrogen produced from renewable energy, i.e., extracted from water using electrolysis and green electricity. Green hydrogen can also be called e-hydrogen. Hydrogen in e-fuels is green hydrogen.

Green House Gas (GHG) is a gas that absorbs and emits radiant energy within the thermal infrared range, causing the greenhouse effect, which is the process by which radiation from a planet's atmosphere warms the planet's surface to a temperature above what it would be without this atmosphere. The primary greenhouse gases in Earth's atmosphere are water vapor (H₂O), carbon dioxide (CO₂), methane (CH₄), nitrous oxide (N₂O), and ozone (O₃).

Green House Gas (GHG) emissions are often measured in carbon dioxide (CO₂) equivalent. To convert emissions of a gas into CO₂ equivalent, its emissions are multiplied by the gas's Global Warming Potential (GWP). The GWP takes into account the fact that many gases are more effective at warming Earth than CO₂, per unit mass. The GWP depends on the time range used in the life cycle analysis.

Green House Gas Emission Score is similar to the above defined Carbon Intensity Score and is typically used in European countries and other applicable countries, using e.g. the Renewable Energy Directive Recast (RED II) directive model.

HHV—higher heating value (also known gross calorific value or gross energy) of a fuel is defined as the amount of heat released by a specified quantity (initially at 25° C.) once it is combusted and the products have returned to a temperature of 25° C., which takes into account the latent heat of vaporization of water in the combustion products.

Input Data are in some cases obtained directly from a sensor, i.e., as a directly measured parameter. In other cases, sensor data from one or more sensors are combined, e.g., as a relative measurement, calibration or compensation, to produce input data for the method. Input data comprise “Input variables” and “Plant data”. In particular, input data include online sensor data and offline data such as feed, utilities and effluent properties, obtained by analytical measures or other.

Input variables are a subset of “Input data” and used as manipulated variables in the optimization of strategy. A manipulated variable is an independent variable subject to adjustments of an optimization strategy to optimize its effect on the objective function—a non-negative measure of plant performance to be minimized. Input variables comprise process variables, underlying variables, benchmark targets, among others.

Plant data refer to data coming from means of registering, such as sensors, analytical measurements or other, relevant for operating and optimizing the renewables plant.

Life cycle assessment or LCA (also known as life cycle analysis) is a methodology for assessing environmental impacts associated with all the stages of the life cycle of a commercial product, process, or service. For instance, in the case of a manufactured product, environmental impacts are assessed from raw material extraction and processing (cradle), through the product's manufacture, distribution and use, to the recycling or final disposal of the materials composing it (grave). Hence, it is a technique to assess environmental impacts associated with all the stages of a product's life from raw material extraction through materials processing, manufacture, distribution, use, repair and maintenance, and disposal or recycling. The results are used to help decision-makers select products or processes that result in the least impact to the environment by considering an entire product system and avoiding sub-optimization that could occur if only a single process were used.

LHV—lower heating value (also known as net calorific value) of a fuel is defined as the amount of heat released by combusting a specified quantity (initially at 25° C.) and returning the temperature of the combustion products to 150° C., which assumes the latent heat of vaporization of water in the reaction products is not recovered.

The term material input is used to signify both input of renewable feedstock and other raw materials into the plant. Examples of other raw materials could for instance be fossil materials. Furthermore, it refers to production or consumption of energy in the process, and to a utilization factor, such as production volume or production rate of product, such as hydrocarbons or other.

For monitoring purposes, cleansed data is used to determine the environmental factor. The direct or indirect measurements are subject to data cleansing, involving data imputation, outlier detection, low-pass filtering, and steady-state estimation. Moreover, the workflow for estimating optimal adjustments to the renewables plant operational setpoints, referred to as independent variables and subject to box constraints and dependent plant design constraints, involves executing an optimization routine. The optimization problem formulation provides the best tradeoff performance between utilization factor, such as product yield and environmental footprint. The final step involves transmitting executable information, constituting the feasible solution to the (open-loop or closed-loop) optimal control problem.

Multi-objective optimization problem involves more than one objective function that may be conflicting, meaning that improvement to one objective may come at the expense of another objective. There is not a single, optimal solution to multi-objective problems, but a set of solutions that represent the optimal tradeoffs between competing objectives.

Open loop system: System in which the output quantity has no effect upon the input to the control system, and that open-loop system is just an open ended non-feedback system, the purpose of which comprises monitoring and measuring. In such a system, feedback may be provided to the operators, which can then be used to adjust the input variable based on recommendations from the system.

Power-to-X (also P2X and P2Y) is a number of electricity conversion, energy storage, and reconversion pathways that use electric power. Power-to-X conversion technologies allow for the decoupling of power from the electricity sector for use in other sectors (such as transport or chemicals), possibly using power that has been provided by additional investments in generation. The X in the terminology can refer to at least one of the following: power-to-ammonia, power-to-chemicals, power-to-fuel, power-to-gas, power-to-hydrogen, power-to-liquid, power-to-methane, power-to-food, power-to-power, and power-to-syngas. Electric vehicle charging, space heating and cooling, and water heating can be shifted in time to match generation, forms of demand response that some term power-to-mobility and power-to-heat. Collectively power-to-X schemes which use surplus power fall under the heading of flexibility measures and are particularly useful in energy systems with high shares of renewable generation and/or with strong decarbonization targets. A large number of pathways and technologies are encompassed by the term.

Renewable feedstock typically comprises one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, methanol based synthesis or a further synthesis process, with the associated benefit of such a process being a process viable for receiving a wide range of feedstocks, especially of renewable origin, such as originating from plants, algae, animals, fish, vegetable oil refining, other biological sources, domestic waste incl. plastic waste and end of life tires, industrial organic waste like tall oil or black liquor. In the particular case of e-fuels, feedstock can be CO₂, hydrogen or (electric) power.

In this context, a Renewable Fuel includes liquid and gaseous fuels and electricity derived from renewable feedstocks, including biomass or energy sources, e.g., to qualify for the Renewable Fuel Standard (RFS) program, the fuel must be intended for use as transportation fuel, heating oil or jet fuel. Examples: Ethanol, biodiesel, cellulosic diesel and compressed natural gas and electricity from renewable biomass. EPA's lifecycle greenhouse gas (GHG) analysis include evaluation of all of the process energy and materials used in a production process (i.e., emissions from the storage and handling of the feedstock, as well as the production, storage and handling of the fuel and co-products). EPA evaluates the lifecycle greenhouse gas emissions of finished fuels that do not require further chemical alteration to be used for their final purpose. A fuel type may be considered a finished fuel if it is blended with another fuel but not chemically altered. For example, EPA evaluates undenatured ethanol as a fuel type, even though it is blended with denaturant and gasoline before it is used as a transportation fuel.

Renewables plant within the scope of the present application means a plant for producing chemicals, including e-chemicals or fuels, including e-fuels at least partly from renewable feedstock or source.

Set point means selected plant outputs the controller must keep at or near specified reference values. Optimal set-points can be determined by closed-loop operations or using an open-loop case where manipulated variables are taken as the desired optimum set points, applying a rolling horizon policy.

Sustainability score or environmental sustainability score is or comprises a Carbon Intensity (CI) score, carbon intensity (CI), a Green House Gas (GHG) emission score, GHG emissions, or another carbon footprint calculation result or metric, or a Life Cycle Assessment (LCA) or LCA score. An improved sustainability score means that the carbon footprint is reduced.

Thermal decomposition as used herein, the term “thermal decomposition” shall for convenience be used broadly for any decomposition process, in which a material is partially decomposed at elevated temperature (typically 250° C. to 800° C. or even 1000° C.), in the presence of substoichiometric amount of oxygen (including no oxygen). The product will typically be a combined liquid and gaseous stream, as well as an amount of solid char. The term shall be construed to include processes known as pyrolysis and hydrothermal liquefaction, both in the presence and absence of a catalyst.

Underlying variables/parameters or Process variables/parameters are relevant for optimization, i.e., variables that can be manipulated in order to obtain improved utilization factors, such as product yields or sustainability scores. These are regarded as input variables.

Utilization factor within the context of the present invention means the metric used in the performance assessment of a renewables plant converting a feedstock into single or multiple renewable fuel or chemical products. A renewables plant producing e-methanol from waste streams, electrolysis hydrogen, and CO₂ capture is an example of a single-product process with one main output stream. Optimal plant utilization of a single-product process typically implies maximizing the single-product production rate, i.e. the single-product mass- or volumetric flow rate. For a renewables plant producing multiple products, e.g. naphtha is a natural byproduct that comes from converting renewable feedstock into diesel, optimal plant utilization implies maximizing the target product yield, i.e. the quantity of the target product formed in relation to the feedstock consumed and usually expressed as a percentage. Utilization factor may therefore refer to, depending on what is being produced at the renewables plant, metrics such as production rate, utility rate, yield, production volume and other.

### DETAILED DESCRIPTION

The present disclosure provides for the following advantages:
A renewable transportation fuel with a lower Carbon Intensity Score (CI score) is a more valuable product,
Hence, continuously monitoring of the CI score and the current trading values of renewable product will significantly improve the overall profitability of the renewables plant,
Monitoring the CI score will also help ensure that the renewables plant is operated as efficiently as possible, resulting in the lowest possible carbon footprint, including CO₂ footprint,
Faster and easier than calculating it manually,
Consistent and auditable data,
Instant reporting capability for authorities (CI scores are continuously calculated and stored and the user can document the GHG emissions to relevant authorities on demand).

In illustrative embodiments, one or more of these advantages can be obtained by a computer-implemented method of controlling production of a chemical or fuel product by a renewables plant at least partly from a renewable feedstock or source, the plant comprising means for registering input data, wherein the method comprises: (a) at a predetermined measuring interval, or continuously, receiving input data obtained from the means for registering input data and indicative of a measure of at least a material input to the production process, a production energy consumption, and a utilization factor, such as production volume or production rate of the chemical or fuel product; (b) at a predetermined calculating interval, or continuously, calculating a sustainability score from the received input data; (c) determining a deviation in the sustainability score; (d) determining an underlying variable as a cause of the deviation; and (e) changing the underlying variable to obtain a target sustainability score. One or more of these advantages can also be obtained by using a computer-implemented system configured to perform this method.

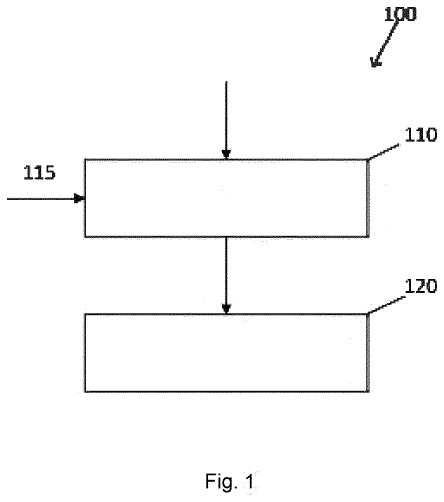

FIG. 1 illustrates a first embodiment of the computer-implemented monitoring method 100 according to the present disclosure. In the first step 110, measured data 115 are received from a plurality of means for registering input data, preferably sensors that are each configured to monitor parameters of a production process in a renewables plant. Means for registering input data used in the present disclosure comprise said sensors but also, in particular, samples from feedstock and intermediate or final products may be collected, analyzed and respective results are stored in a database with a timestamp for when the sample was taken.

In a preferred embodiment of the present disclosure, sensors are embedded in the renewables plant so as to at least provide a direct or indirect measurement of material input to the production process, e.g., a direct or indirect measurement of a production energy consumption, and a direct or indirect measurement of a utilization factor such as production volume or production rate of a hydrocarbon rich product. If the production process, e.g catalytic conversion process, requires more than one material input, typically more than one sensor will be used. Likewise, if more than one chemical product is produced, typically more than one sensor will be used to measure a utilization factor such as production volume. Many different sensors may be employed, such as fluid flow sensors, temperature sensors, pressure sensors, electric consumption meters, chemical sensors, etc. From the abovementioned sensor data, a sustainability score 120 is calculated. Different sustainability scores may be used, depending on the legislation at the location of production and/or the location of sale of the product. Examples of sustainability scores are Carbon Intensity (CI), Green House Gas (GHG) emissions, carbon footprint calculation, or a Life Cycle Assessment (LCA).

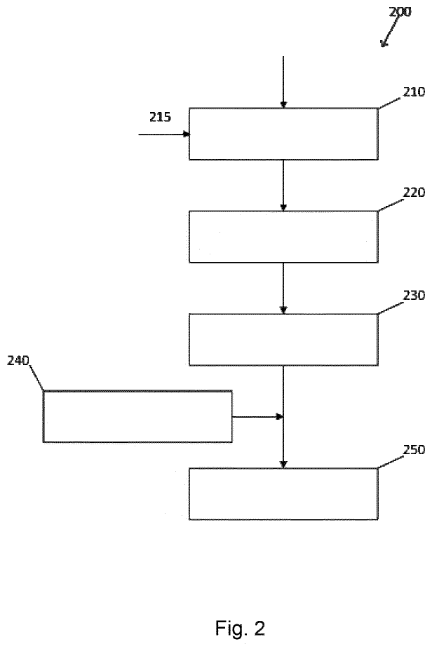

FIG. 2 illustrates a second embodiment of the monitoring method 200 that relates to the first embodiment of the present disclosure, described above for FIG. 1 where similar reference numerals refer to similar parts. Therefore, only the differences between the two embodiments will be described here. After the sustainability score 220 is calculated, an evaluation 230 is made of the current status of the production process. For comparison, a desired or expected status 240 is provided, preferably as one or more of a past status, a set point, and a simulated status is evaluated. Finally, the observed current status 230 and the desired or expected status 240 is compared so as to identify any deviation between the two. Such a deviation may then be reported to an operator of the plant, thus allowing for the adjustment of one or more process parameters.

Alternatively, in some preferred embodiments, such a deviation may be converted to executable information that is subsequently transmitted to the operator, or directly to a control system of the plant. A deviation in the measured data 215 is a result of a deviation in an underlying variable or parameter. For instance, a reaction in a catalytic reactor may be exothermal, in which case an observed rise in temperature of the catalytic bed may in fact be caused by a flow of feedstock being too high or a flow of quench gas or recycle being too low. Thus, the underlying parameter may rather be the flowrate rather than the temperature per se. When it has been established which change in the underlying variables cause a deviation in the observed sensor values and thus in the calculated sustainability score, opposing changes may be made in these underlying parameters so as to realize the expected or desired sustainability score.

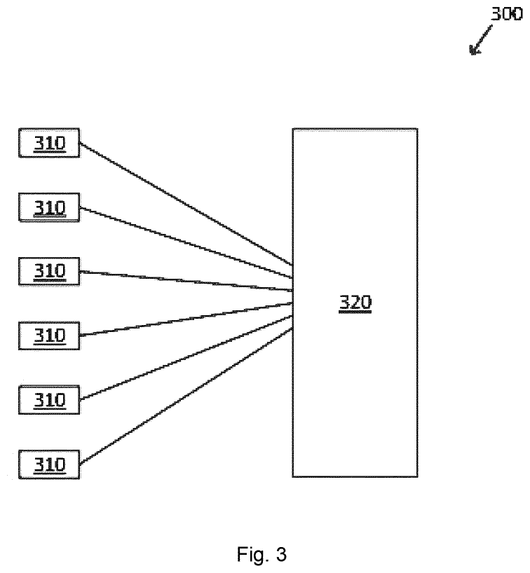

FIG. 3 illustrates a monitoring system 300 according to a third embodiment of the disclosure. The monitoring system 300 is related to the computer-implemented monitoring method 100 or 200 as described above. Therefore, only the details specific to this system 300 are described here. The system 300 comprises a plurality of sensors 310, for providing the input measured (e.g., via sensor) data as discussed above for FIGS. 1 and 2. The sensors 310 are in communication with a data-processing system 320 that is adapted for performing the monitoring method 100, 200 as discussed above.

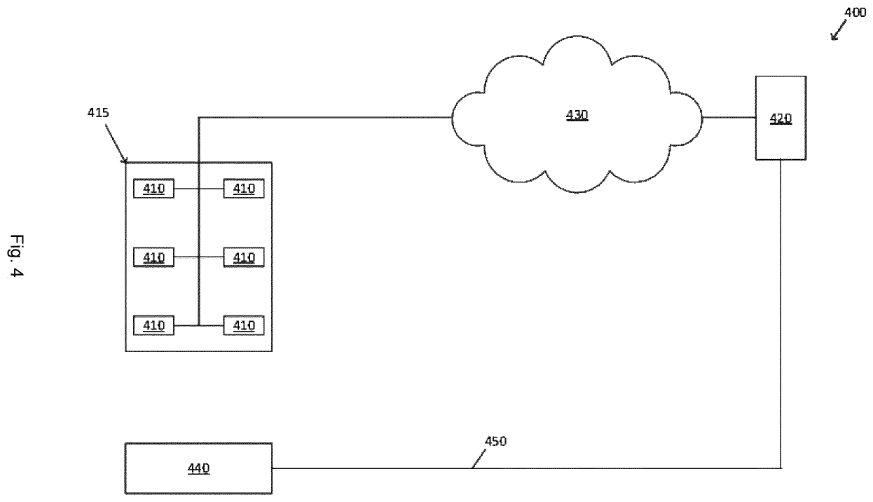

FIG. 4 illustrates a monitoring system 400 according to a fourth embodiment of the disclosure. This embodiment relates to the one shown in FIG. 3 where similar reference numerals refer to similar parts. Therefore, only the differences between the two embodiments will be described here. Like the embodiment shown in FIG. 3, the data-processing system 420 is in communication with a plurality of sensors 410. However, in this embodiment, the sensors 410 are disposed at a location of the renewables plant and provide measured data 415, while the data-processing system 420 is located remotely and connected to the sensors 410 via a data network 430, such as the internet. In the embodiment shown here, not to be regarded as limiting, an output from the data-processing system 420 is sent to an operator 440 via a communication link 450. The operator 440 may be located at the plant, or may be in a different location. Also, the communication link 450 may be a separate link as shown here, or it may be via the data network 430. In this way, the data-processing system 420 may be used for monitoring multiple plants. This also enables a service provider to provide these monitoring capabilities as a service to plant operators. An open loop system may be in place, for measuring and monitoring data but the current embodiment may further comprise transmitting executable information to the renewables plant via a communication network, i.e., an output with one or more executable instructions (e.g., in a closed loop system) from the data-processing system 420 is sent to an operator 440 via a communication link 450 or data network 430.

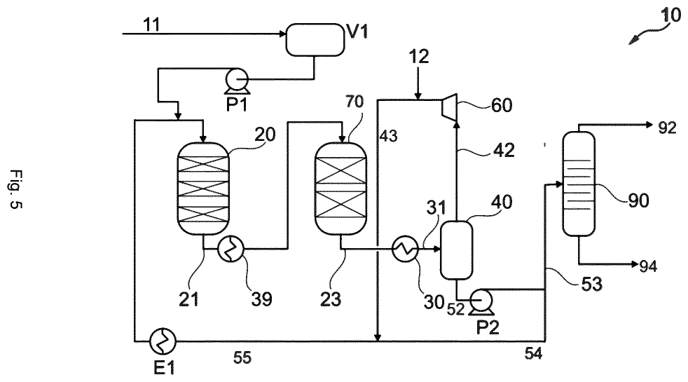

FIG. 5 shows an oxygenate and hydrocarbon comprising feedstock 11. This stream is sent to a feed surge drum V1 and then fed to a high pressure system by pump P1. The feedstock is combined with a heated hydrocarbon recycle steam and a hydrogen-rich recycle gas stream (55), before being sent to a hydrotreating reactor (20). This first reactor contains catalyst active for hydrotreatment, and this catalyst catalyzes conversion of the oxygen present in the hydrocarbon feedstock to water, CO2 and CO, as well as other reactions like saturation of olefins to paraffins, conversion of nitrogen to ammonia and conversion of sulfur to hydrogen sulfide. The hydrotreated product stream (21) is optionally heated or cooled by heat exchanger (39) and then sent to a hydroisomerization reactor (70). This second reactor contains catalyst active for hydroisomerization, and this catalyst converts linear paraffins with a high pour point to branched iso-paraffins with a lower pour point, and thereby improves the cold flow properties of the stream. The hydroisomerized product (23) is cooled by heat exchange with other process streams, cooling water and/or ambient air in a cooling unit (30), and the cooled stream (31) is sent into a high pressure separator (40). This separator splits the hydrotreated and hydroisomerized product into a hydrogen-rich gas stream (42), a hydrocarbon-rich liquid stream (52), and optionally a water-rich liquid stream (not shown). The hydrogen-rich stream is sent to a recycle gas compressor (60), and re-compressed gas stream is combined with hydrogen make-up gas (12) into treat gas (43) and then combined with recycle hydrocarbon stream (54). The hydrocarbon-rich liquid stream (52) is passed through pump P2, and then split into a liquid recycle hydrocarbon stream (54) and a hydrocarbon product stream (53). The liquid recycle hydrocarbon stream (54) is combined with the treat gas (43) and heated in heat exchanger E1 to achieve the proper reaction temperature in the hydrotreating reactor (20). The hydrocarbon product stream (53) is sent to a separation unit (90), where the main liquid product diesel (94) is stabilized by removal of light components (92) like naphta, LPG and fuel gas.

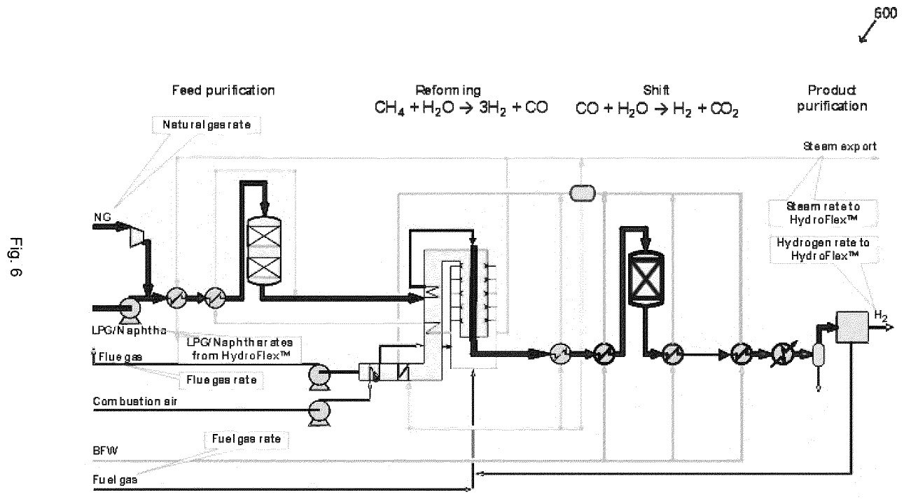

FIG. 6 shows an example of a hydrogen production plant 600 useful in combination with the monitoring system according to the disclosure.

Monitoring the production process of this plant may comprise registering any of the following parameters:
Natural gas input rate
LPG/Naphtha input rates
Fuel gas input rate
Flue gas output rate
Steam export rate
Hydrogen production rate
Temperatures and pressures of all streams
Electrical consumption for rotating equipment (pumps, compressors, etc.)

FIG. 7 is a block diagram illustrating an exemplary configuration of a computing device 120 which configured to perform the computer-implemented monitoring and control methods disclosed here in exemplary embodiments. The computing device 120 includes various hardware and software components that function to perform the methods according to the present disclosure. The computing device 120 can comprise a user interface 150, a processor 155 in communication with a memory 160, and a communication interface 165. The processor 155 functions to execute software instructions that can be loaded and stored in the memory 160. The processor 155 may include a number of processors, a multi-processor core, or some other type of processor, depending on the particular implementation. The memory 160 may be accessible by the processor 155, thereby enabling the processor 155 to receive and execute instructions stored on the memory 160. The memory 160 may be, for example, a random access memory (RAM) or any other suitable volatile or non-volatile computer readable storage medium. In addition, the memory 160 may be fixed or removable and may contain one or more components or devices such as a hard drive, a flash memory, a rewritable optical disk, a rewritable magnetic tape, or some combination of the above.

One or more software modules 170 may be encoded in the memory 160. The software modules 170 may comprise one or more software programs or applications having computer program code or a set of instructions configured to be executed by the processor 155. Such computer program code or instructions for carrying out operations for aspects of the systems and methods disclosed herein may be written in any combination of one or more programming languages.

The software modules 170 may include a program for performing perform the computer-implemented monitoring and control methods disclosed here in exemplary embodiments and one or more additional applications configured to be executed by the processor 155. During execution of the software modules 170, the processor 155 configures the computing device 120 to perform various operations relating to the computer-implemented monitoring and control according to embodiments of the present disclosure.

Other information and/or data relevant to the operation of the present systems and methods, such as a database 185, may also be stored on the memory 160. The database 185 may contain and/or maintain various data items and elements that are utilized throughout the various operations of computer-implemented monitoring and control. It should be noted that although the database 185 is depicted as being configured locally to the computing device 120, in certain implementations the database 185 and/or various other data elements stored therein may be located remotely. Such elements may be located on a remote device or server—not shown, and connected to the computing device 120 through a network in a manner known to those skilled in the art, in order to be loaded into a processor and executed.

Further, the program code of the software modules 170 and one or more computer readable storage devices (such as the memory 160) form a computer program product that may be manufactured and/or distributed in accordance with the present disclosure, as is known to those of skill in the art.

The communication interface 165 can also be operatively connected to the processor 155 and may be any interface that enables communication between the computing device 120 and external devices, machines and/or elements including, e.g., a server or other computer. The communication interface 165 is configured for transmitting and/or receiving data. For example, the communication interface 165 may include but is not limited to a Bluetooth, Wi-Fi or cellular transceiver, a satellite communication transmitter/receiver, an optical port and/or any other such, interfaces for wirelessly connecting the computing device 120 to the server or other computer.

A user interface 150 can also be operatively connected to the processor 155. The user interface may comprise one or more input device(s) such as switch(es), button(s), key(s), and a touchscreen. The user interface 150 functions to allow the entry of data. The user interface 150 functions to facilitate the capture of commands from the user such as an on-off commands or settings related to operation of the above-described method.

A display 190 can also be operatively connected to the processor 155. The display 190 may include a screen or any other such presentation device that enables the user to view various options, parameters, and results, such as the group identifiers. The display 190 may be a digital display such as an LED display. The user interface 150 and the display 190 may be integrated into a touch screen display. The operation of the computing device 120 and the various elements and components described above will be understood by those skilled in the art with reference to computer-implemented monitoring and control.

It will be understood that what has been described herein is an exemplary system for effecting computer-implemented monitoring and control. While the present disclosure has been described with reference to exemplary arrangements it will be understood that it is not intended to limit the disclosure to such arrangements as modifications can be made without departing from the spirit and scope of the present teaching. The method of the present teaching may be implemented in software, firmware, hardware, or a combination thereof. In one mode, the method is implemented in software, as an executable program, and is executed by one or more special or general purpose digital computer(s). The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface.

The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

It will be appreciated that the system may be implemented using cloud or local server architecture. In this way it will be understood that the present teaching is to be limited only insofar as is deemed necessary in the light of the appended claims.

### PREFERRED EMBODIMENTS

1. Computer-implemented monitoring method for a renewables plant, the plant being configured for production of a chemical or fuel product at least partly from a renewable feedstock or source, the plant comprising means for registering input data, the method comprising:
   a) receiving input data indicative of a measure of at least one of a material input to the production process, a production energy consumption, and a utilization factor such as production volume or production rate of the chemical or fuel product,
   b) calculating a sustainability score from the received input data.
This way, an efficient monitoring of the sustainability score for the production process may be achieved.
The common practice so far is for an appointed accreditor to visit a plant periodically, gather all the relevant input data (which is time consuming) and validate the Carbon Intensity/GHG emissions against the pathway application filed previously (sometimes years ago) by the plant. The present disclosure on the other hand provides for continuous monitoring of GHG emissions by Connected Services, allowing the plant owner/operator to plan ahead and make modifications, e.g., to optimize the unit operations and plan for catalyst replacement, preventing or minimizing interruption of the operation, minimizing costly turnaround time, ensuring maximum catalyst performance, maximizing catalyst lifetimes and improving production and reducing costs. One of the most important factors for hydroprocessing unit profitability is the length of time that the catalyst remains active. No matter how high a catalyst's start-of-run activity is, if it deactivates more rapidly than expected, the unit performance will suffer and profits will drop. A major cause of premature catalyst deactivation is impurities in feedstocks. For example, nickel, vanadium, iron, silicon, arsenic, phosphorus, and/or sodium are often present in feedstocks at ppb or even ppm levels, and the effect on downstream catalysts can be devastating. Indeed, due to catalyst deactivation, the reactor temperature has to be increased regularly to keep the product specifications on target for example. Such an increase in temperature will cause an increase in fuel gas and/or electricity consumption and might cause an increase in GHG emissions. Furthermore, as the catalyst deactivate, hydrogen consumption is also likely to increase. Therefore, there might be a tipping point in terms of GHG emissions and profitability during cycle length that such a GHG monitoring tool could identify. So, there are advantages to monitoring the CI score or GHG emission score continuously instead of calculating it every time a product, e.g., fuel, needs to be certified.

The present disclosure provides for the following advantages:
A renewable transportation fuel with a low Carbon Intensity Score (CI score) is a more valuable product, which means that said fuel is more valuable in terms of environmental impact and often profitability in the plant, when compared to a renewable transportation fuel with a higher CI score,
Hence, continuously monitoring of the CI score and the current trading values of renewable product will significantly improve the overall profitability of the renewables plant,
Monitoring the CI score will also help ensure that the renewables plant is operated as efficiently as possible, resulting in the lowest possible Carbon footprint, including CO2 footprint,
Faster and easier than calculating it manually,
Consistent and auditable data,
Instant reporting capability for authorities (CI scores are continuously calculated and stored and the user can document the GHG emissions to relevant authorities on demand).
In general, the production process may involve process input of raw materials of renewable origin and optionally one or more of the following: thermal energy, electrical energy, and raw materials of fossil origin. The production process produces a process output of a chemically or catalytically transformed product and optionally one or more of the following: thermal energy, electrical energy, products associated with deposition value, and products associated with deposition cost. The process inputs and process outputs are related to optimization and a net value of the production is calculated from the individual costs and values, a commercial value and an environmental cost. In some cases, input data for the method is obtained directly from a sensor, i.e., as a directly measured parameter. In other cases, sensor data from one or more sensors are combined, e.g., as a relative measurement, calibration or compensation, to produce input data for the method.
In some embodiments, the method comprises data cleansing of the input data before calculating the sustainability score. This may comprise outlier detection/removal, low-pass filter, and steady-state detection. Data cleansing may be performed as part of the measurements of the individual sensors, when combining sensor data from one or more sensors, or as the input data is received for calculating the sustainability score. Data cleansing can also comprise reconciliation, where the measured data are corrected to ensure that the overall plant mass and energy balance is fulfilled.
In this context, a renewables plant is to be understood as a plant for producing chemicals or fuels, at least partly from renewable feedstock.
In an embodiment, the chemical product may be 1) an oxygenate such as methanol, DME or ethanol, 2) a hydrocarbon, 3) hydrogen, 4) synthesis gas, 5) ammonia or 6) gasoline from alcohols. The fuel product may be one of the following: transportation fuels or petrochemical raw materials such as diesel, gasoline, aviation fuel, fuel oil, marine fuel, ammonia, hydrogen, lubricant, and naphtha.
In a preferred embodiment, a production process is/are type(s) of technology used to convert renewable biomass or waste into chemical or fuel products. Examples: Hydroprocessing, gasification and upgrading, transesterification using natural gas or biomass for process energy, green ammonia technologies, etc. Co-processing of fossil and renewable feedstocks to manufacture chemical or fuel products is one of the preferred embodiments in the present disclosure. The US Environmental Protection Agency lifecycle greenhouse gas analysis includes evaluation of all of the process energy and materials used in a production process (i.e., emissions from the storage and handling of the feedstock, as well as the production, storage and handling of the fuel and co-products). EPA may restrict the production process based on what types of process energy it uses. In some examples, both fossil and renewable feedstock is used to produce the chemical product.
2. Computer-implemented monitoring method according to embodiment 1 wherein the means for registering input data include a plurality of sensors, and said input data is based on measurements by one or more of the plurality of sensors.
3. Computer-implemented monitoring method according to embodiment 1 or 2, wherein the sustainability score is or comprises a Carbon Intensity (CI) score, a Green House Gas (GHG) emission score, or another carbon footprint score, or a Life Cycle Assessment (LCA) score.
An emission intensity (such as a carbon intensity, CI) is the emission rate of a given pollutant relative to the intensity of a specific activity, or an industrial production process; for example, grams of carbon dioxide released per megajoule of heating value of the fuel produced (LHV or HHV), or the ratio of greenhouse gas (GHG) emissions produced to gross domestic product (GDP). Emission intensities are used to derive estimates of air pollutant or greenhouse gas emissions based on the amount of fuel combusted, the number of animals in animal husbandry, on industrial production levels, distances traveled or similar activity data. Emission intensities may also be used to compare the environmental impact of different fuels or activities. In some case the related terms emission score and carbon intensity are used interchangeably. The jargon used can be different, for different fields/industrial sectors; normally the term “carbon” excludes other pollutants, such as particulate emissions. One commonly used figure is carbon intensity per kilowatt-hour (CIPK), which is used to compare emissions from different sources of electrical power.
In EU-27, new units producing biofuels have requirements with respect to GHG emissions with a minimum savings of 65% compared to fossil fuel, for units that started producing renewable fuels in 2021 (i.e., max. 32.9 g CO2 eq/MJ of biofuels), as well as other targets depending on local regulations.
In an embodiment of the present disclosure, the production process comprises one or more of: an Oxygenate production such as Methanol production, Ethanol production, DME production, or Hydrocarbon production; hydrogenation of vegetable oil or hydrogenation of thermal decomposition products, such as hydrogenation of pyrolysis oil or hydrogenation of hydrothermal liquefaction oil; Hydrogen production; Synthesis gas production; Gas to liquid; Gasoline synthesis from alcohols; and Ammonia production.
Renewables Identification Number (RINs) are credits used for compliance, and are the “currency” of the Renewable Fuel Standard (RFS) program. In the USA, the Renewable Fuel Standard (Federal program) has specific targets of renewable fuel production (or renewable volume obligation). The volume targets are adjusted annually by the Environmental Protection Agency and fuels must reach a set GHG reduction threshold to qualify as renewable. An assigned RIN of a batch of renewable fuel is impacted by the CI of the batch. Thus, the CI of a batch influences the value of the batch and thereby the profit of the production process. Renewable fuel producers generate RINs, Market participants trade RINs and Obligated parties obtain and then ultimately retire RINs for compliance. RI Ns can be traded in two forms:
(i) Assigned RINs—directly associated with a batch of fuel and that travel with that batch of fuel from party to party and Purchasers obtain both the renewable fuel and RINs together or
(ii) Separated RINs—formerly assigned with a batch of fuel but are no longer assigned to a batch and Purchasers obtain only the RIN.
Examples of typical RIN transactions include:
a) Generate—when a fuel is produced, a RIN is generated,
b) Buy—when an assigned/separated RIN is bought/traded by a buyer from a seller
c) Sell—when an assigned/separated RIN is sold/traded by a seller to a buyer
d) Separate—when a RIN is separated from the fuel to which it was originally assigned
e) Retire—when a RIN is used to demonstrate compliance or required to be retired for other purposes.
Renewable Identification Number (RIN) Renewable Fuel Category (D-Code) By statute, the RFS program includes four categories of renewable fuel, each with specific fuel pathway requirements and RIN D-Codes: a) Advanced Biofuel (D-code 5): Can be made from any type of renewable biomass except corn starch ethanol. Must reduce lifecycle greenhouse gas emissions by at least 50%; compared to the petroleum baseline.
b) Biomass-based Diesel (D-Code 4): Examples include biodiesel and renewable diesel. Must reduce lifecycle greenhouse gas emissions by at least 50%; compared to the diesel baseline.
c) Cellulosic Biofuel (D-Code 3 or D-Code 7): Renewable fuel produced from cellulose, hemicellulose or lignin.
To be eligible for D-Code 7 RINs the fuel must be cellulosic diesel. Must reduce lifecycle greenhouse gas emissions by at least 60%; compared to the petroleum baseline.
d) Renewable Fuel (D-Code 6): Includes ethanol derived from corn starch, or any other qualifying renewable fuel. Fuel produced in new facilities or new capacity expansions (commenced constructed after Dec. 19, 2007) must reduce lifecycle greenhouse gas emissions by at least 20%; compared to the average 2005 petroleum baseline.
A Renewable Fuel Pathway for RFS includes three critical components: (1) feedstock, (2) production process and (3) fuel type. Each combination of the three components is a separate fuel pathway. Qualifying fuel pathways are assigned one or more D codes representing the type of Renewable Identification Number (RI N) (i.e., renewable fuel, advanced biofuel, biomass-based diesel, cellulosic biofuel or cellulosic diesel) they are eligible to generate.
4. Computer-implemented monitoring method according to any one of embodiments 1, 2 or 3, wherein at least some of the input data are related to liquid, gaseous, or solid streams, and comprise a mass flow, a volume flow, a temperature, a pressure, a chemical composition, and/or electrical consumption.
5. Computer-implemented monitoring method according to embodiment 4, wherein said gaseous streams comprise H₂ or feed streams to the hydrogen plant steam reformer.
6. Computer-implemented monitoring method according to embodiment 5, wherein at least one of said gaseous streams is a stream comprising at least 75 vol %, 80 vol %, 90 vol % or 99 vol % H₂ or feed streams to the hydrogen plant steam reformer.
7. Computer-implemented monitoring method according to any one of the preceding embodiments, wherein the input data are received at regular intervals and/or continuously.
8. Computer-implemented monitoring method according to any one of embodiments 1 to 6, wherein the input data are received in real time.
For instance, the regular intervals may be daily, hourly, per minute or similar regular intervals or combinations thereof for different input data (e.g., minute data for temperature but daily for feedstock). All sensors do not need to be sampled at identical intervals, i.e., input data related to some sensors may, e.g., be received daily, while other sensors provide data in real time, near-real time, or according to another interval.
9. Computer-implemented monitoring method according to any one of the preceding embodiments, wherein a display device interactively displays input data, the display device being configured for graphically or textually receiving an input signal from the monitoring system via a dedicated communication infrastructure, creating an interactive display for a user.
In a preferred embodiment, utilization factors, e.g. product yields and emissions/sustainability scores are displayed on the display device.
In another preferred embodiment, based on a hue and color technique, which discriminates the quality of the displayed input data, e.g., plant data; and generating a plant process model using the input data, e.g., plant data for predicting plant performance expected based on said data, the plant process model being generated by an iterative process that models based on at least one plant constraint being monitored for the operation of the plant.
10. Computer-implemented monitoring method according to embodiment 9 wherein utilization factors, e.g. product yields and emissions or sustainability scores are displayed on the display device.
11. Computer-implemented monitoring method according to any of the previous embodiments further comprising optimizing the production process, comprising:
   a) evaluating the current status and the set point of the production process using the means for registering input data and monitoring parameters of the production process,
   b) cleansing the input data before calculating the sustainability score,
   c) solving a multi-objective optimization problem subject for maximizing a utilization factor such as the product yield and minimizing the environmental footprint of the production process, the emissions from processing, by means of manipulating at least one of a plurality of input variables.
In this way, the monitoring method comprises optimizing the production process with regard to different objectives, such as maximizing a utilization factor, such as product yield and/or minimizing an environmental footprint of the production process, using cleansed plant data. Data cleansing may be performed in any one of a multitude of ways, such as outlier detection/removal, low-pass filter, and steady-state detection. Data cleansing may be performed as part of the measurements of the individual sensors, when combining sensor data from one or more sensors, or as the input data is received for calculating the sustainability score.
The production process is optimized with respect to utilization factors, e.g. renewable product yields while minimizing and/or meeting upper constraints on the emissions from processing, thereby possibly obtaining more valuable products. Consequently, the balance between utilization factors, e.g. renewable product yields and emissions from processing is inherent in the optimization problem formulation by weighting of objectives, possibly using a weighted sum strategy to convert the multi-objective problem into a scalar problem by constructing a weighted sum of all the objectives.
In one embodiment, the method comprises simulating or predicting impact of a change in raw materials/feedstock and/or operational related manipulations to the process on both utilization factors, e.g. yields and emissions from processing.
   Adjustments to the process should target maximizing utilization factors, e.g. product yields while minimizing the environmental footprint. These could be two competing objectives.
   Simulation/prediction capabilities to provide the impact of a change in raw materials or operational related changes to the process on both utilization factor, e.g. yield and CI score or sustainability score or environmental sustainability score.
12. Computer-implemented monitoring method according to any one of the previous embodiments, further comprising transmitting executable information to the renewables plant via a communication network.
The optimization problem formulation provides the best tradeoff performance between utilization factor, e.g. product yield and sustainability score. Subsequently, executable information, constituting the feasible solution to the possibly open- or closed-loop optimization problem, is transmitted to adjust the renewables plant control system setpoints accordingly. Hence, the executable information determines how to adjust the renewables plant control system setpoints based on the desired weighting of utilization factor, such as product yield and sustainability score as well as the plant data associated with the current setpoint of the production process.
In one embodiment, the operator of the plant may be informed of the optimal setpoint adjustments, thus enabling the operator to intervene in the production process, if desired. Reporting to the operator of the plant may be performed in any one of a multitude of ways, such as by an information display, email, web service, dedicated notification network, etc.
13. Computer-implemented monitoring method according to any one of the previous embodiments further comprising calculating improved values for one or more underlying variables, and reporting the calculated improved values to an operator of the plant.
In this way, suggested values for improving plant performance may be identified and provided to the operator. The operator may then choose to adjust production parameter wholly or partly according to the suggestions, or may choose to make other adjustments. Thus, the responsibility for operation of the plant remains with the operator, while the monitoring method merely provides guidance for the operator.
14. Computer-implemented monitoring method according to any one of the preceding embodiments, further comprising:
   setpoint tracking and identifying optimal setpoint deviations in one or more of the manipulated underlying variables causing an undesired effect. Such undesired effect may be an observed decrease in utilization factors, e.g. product yields and/or worsening (as opposite to improving or maintaining) of the sustainability score. An example of worsening the sustainability score may be an increase of said sustainability score, when the targeted sustainability score is low (e.g. CI score).
15. Computer-implemented monitoring method according to any one of the preceding embodiments further comprising adjusting one or more underlying variables in response to the observed deviations.
In this way, the production process may automatically be adjusted to provide a more optimal operation, i.e., with regards to maximizing utilization factor, e.g. yield and/or optimizing the sustainability score.
16. Computer-implemented monitoring method according to any one of the preceding embodiments, wherein the improved values for one or more of the underlying variables are calculated to improve the sustainability score of the production process and/or a utilization factor, e.g. product yield.
In this way, the production may be optimized to provide an improved renewable fuel, e.g., having a lower sustainability score (e.g., Carbon Intensity score) or having a higher sustainability score (e.g., GHG emission score), thereby possibly obtaining a more valuable product. The tradeoff between a utilization factor such as product yield or other and sustainability score may be optimized in this way, to improve plant profitability and lower environmental footprint. In some cases, by-products of the production process may either be sold by themselves, or may be used in the production process, possibly replacing fossil or other types of fuel. In that case, the optimization should preferably take into account whether to use the by-products or not.
The improved values are the recommendation to the operator of the plant and refer to the values at which the input variables should be set, in order to improve the sustainability score. In particular, these improved value(s) refer to taking one or more of the underlying/input variables and re-calculating to improve the sustainability score. Based on said improved value(s), input variables should be changed in order to achieve improved sustainability score of the production process and/or a utilization factor, such as product yield or other.
17. Computer-implemented monitoring method according to any one of the preceding embodiments, wherein the production process comprises a catalytic reaction step, and the method comprises receiving input data for temperature and pressure in the catalytic reaction step.
18. Computer-implemented monitoring method according to embodiment 17 wherein the replacement of catalysts is optimized, being scheduled as a result of calculations based on input data.
19. Data-processing system for performing the computer-implemented monitoring method according to any one of the preceding embodiments, said data-processing system comprising a server, the server being located distant from the renewables plant and being connected to the internet.
Computer-implemented monitoring system for a renewables plant providing a display device for calculating and interactively displaying input data and sustainability scores, the display device being configured for graphically or textually receiving an input signal, using a human-machine interface via a dedicated communication infrastructure, said monitoring system comprising:
   the means for registering input data;
   the data-processing system according to embodiment 19, wherein said system is coupled to a server for communicating with a plant via a communication network, using a web-based platform for receiving and/or sending input data, e.g., plant data related to the operation of the plant over the network.
21. Computer-implemented monitoring system for a renewables plant according to embodiment 20, wherein said means for registering input data are a plurality of sensors located at the renewables plant, configured for transmitting sensor data to the server via the internet.
22. Computer-implemented monitoring system for a renewables plant according to embodiment 21, wherein said plurality of sensors monitor the same or different underlying variables or parameters of the production process.
23. Computer-implemented monitoring system for a renewables plant according to any of embodiments 20 to 22, wherein said plurality of sensors are located along a reactor to collect data from different positions in the same location of the equipment.
24. Plant for production of a chemical or fuel product, at least partly from a renewable feedstock or source, the plant comprising a data processing system according to embodiment 19 and a monitoring system according to any of embodiments 20 to 23, the plant comprising the means for registering input data and being arranged such that:
   a) input data indicative of a measure of at least a material input to the production process, a production energy consumption, and a utilization factor, such as production volume or production rate of the chemical product are received,
   b) a sustainability score from the received input data is calculated.
25. Plant according to embodiment 24, wherein the means for registering input data are one or more sensors.
26. Plant according to any one of embodiments 24 or 25, wherein said plant is arranged for production of a chemical or fuel product via hydroprocessing, hydrogen production, ammonia production or production of methanol, ethanol, naphtha, synthesis gas, jet fuel, diesel, from renewable feedstocks or sources, including e-chemicals and e-fuels.
27. Plant according to embodiment 26 wherein chemical product is 1) an oxygenate such as methanol, DME or ethanol, 2) a hydrocarbon, 3) hydrogen, 4) synthesis gas, 5) ammonia or 6) gasoline from alcohols.
28. Plant according to embodiment 26 wherein the fuel product is a transportation fuel or petrochemical raw materials such as diesel, gasoline, aviation fuel, fuel oil, marine fuel, ammonia, hydrogen, lubricant, and naphtha.
29. Computer-implemented method of controlling production of a chemical or fuel product by a renewables plant at least partly from a renewable feedstock or source, the plant comprising means for registering input data, the method comprising:
   a) at a predetermined measuring interval, or continuously, receiving input data indicative of a measure of at least a material input to the production process, a production energy consumption, and a utilization factor, such as production volume or production rate of the chemical or fuel product;
   b) at a predetermined calculating interval, or continuously, calculating a sustainability score from the received input data;
   c) determining a deviation in the sustainability score;
   d) determining an underlying variable as a cause of the deviation; and
   e) changing the underlying variable to obtain a target sustainability score.
30. Computer-implemented system for controlling production of a chemical or fuel product by a renewables plant at least partly from a renewable feedstock or source, the plant comprising means for registering input data, the system being configured for:
   a) at a predetermined measuring interval, or continuously, receiving input data indicative of a measure of at least a material input to the production process, a production energy consumption, and a utilization factor, such as production volume or production rate of the chemical or fuel product;
   b) at a predetermined calculating interval, or continuously, calculating a sustainability score from the received input data;
   c) determining a deviation in the sustainability score;
   d) determining an underlying variable as a cause of the deviation; and
   e) changing the underlying variable to obtain a target sustainability score.

### EXAMPLE 1

The present example details the optimization of a product stripper in a sustainable diesel unit. The product stripper is a distillation column with a condenser and a reboiler, and the purpose of the stripper is to produce a stabilized diesel product, where all light material like off-gas and naphtha is removed. Typically the target for operating such a stripper is to achieve a certain flash point value of the diesel product. In this example, the column is operated in order to achieve a diesel product flash point of 55° C.

The separation between diesel and naphtha is controlled by the energy input to the stripping column in the reboiler and condenser. The more energy that is supplied to the stripper, the better the separation between the products become, and the more diesel product can be extracted while still meeting the specified flash point. In this example, the three operating cases were considered:

| | | | |
|---|---|---|---|
| Condenser duty (MW) | 16.6 | 15.7 | 15.6 |
| Reboiler duty (MW) | 24.5 | 23.2 | 22.8 |
| Total duty (MW) | 41.1 | 39.0 | 38.4 |
| Diesel product rate, | 189,693 | 187,382 | 185,015 |
| kg/hr | | | |
| Relative duty, % | 100% | 95% | 93% |
| Relative diesel rate, % | 100.0% | 98.8% | 97.5% |

As observed, reducing the total energy input also reduces the amount of diesel product which illustrates the trade-off between energy use (that increases the GHG emissions of the process) and the diesel utilization factor, such as product rate (that increases the plant profitability).

Additionally, co-products such as LPG (liquefied petroleum gas) or naphtha may be recycled to the H₂ unit in order to minimize use of natural gas (for example) and therefore minimize the GHG emissions of the hydroprocessing step.

### EXAMPLE 2

Table 1 illustrates the value of continuous monitoring of carbon intensity CI. The example illustrates the development of CI from start of run (SOR) to end of run (EOR) for a hydroprocessing plant producing renewable diesel. The plant consumes hydrogen, which in part is produced from natural gas. In addition an amount of electricity is also consumed by the plant.

TABLE 1

| | | SOR | EOR |
|---|---|---|---|
| Diesel produced | lb/lb feed | 0.789 | 0.759 |
| Natural gas | BTU/lb diesel | 170 | 177 |
| Natural gas Carbon | g CO2/lb diesel | | |
| Electricity | BTU/lb diesel | 75 | 78 |
| Electricity Carbon | g CO2/lb diesel | | |
| Total energy | BTU/lb diesel | 3037 | 3366 |
| Cl | g CO2/MJ | 12.8 | 13.85 |

At start of run (SOR) compared to end of run (EOR) more diesel is produced and less natural gas and electricity is consumed, and the conventional approach to this variation in the registration of CI has been to predict the worst case and ensure compliance with that value. In Table 1, this would be the EOR situation.

Therefore by employing a continuous CI monitoring and auditable documentation, it is possible to document a lower CI value, compared to the worst case scenario otherwise required. In the case of Table 1 this would in practice mean an interpolation between the SOR value and the EOR, such that the reported CI would be the average of the two; 13.36 g CO₂/MJ, which can be used for achieving additional profit in a plant, based on a carbon credit scheme.

1. Computer-implemented monitoring method for a renewables plant, the plant being configured for production of a chemical or fuel product at least partly from a renewable feedstock or source, the plant comprising means for registering input data, the method comprising:
a) receiving input data indicative of a measure of at least a material input to the production process, a production energy consumption, and a utilization factor,
b) calculating a sustainability score from the received input data.

2. Computer-implemented monitoring method according to claim 1 wherein the means for registering input data include a plurality of sensors, and said input data is based on measurements by one or more of the plurality of sensors.

3. Computer-implemented monitoring method according to claim 1, wherein the sustainability score is or comprises a Carbon Intensity score, a Green House Gas (GHG) emission score, or another carbon footprint score, or a Life Cycle Assessment (LCA) score.

4. Computer-implemented monitoring method according to claim 1, wherein at least some of the input data are related to liquid, gaseous, or solid streams, and comprise a mass flow, a volume flow, a temperature, a pressure, a chemical composition, and/or electrical consumption.

5. Computer-implemented monitoring method according to claim 4, wherein at least one of said gaseous streams is a stream comprising at least 75%, vol % H₂ or feed streams to the hydrogen plant steam reformer.

6. Computer-implemented monitoring method according to claim 1, wherein the input data are received at regular intervals and/or continuously and/or in real time.

7. Computer-implemented monitoring method according to claim 1, wherein a display device interactively displays input data, the display device being configured for graphically or textually receiving an input signal from the monitoring system via a dedicated communication infrastructure, creating an interactive display for a user.

8. Computer-implemented monitoring method according to claim 7 wherein utilization factors are displayed on the display device.

9. Computer-implemented monitoring method according to claim 1 further comprising optimizing the production process, comprising:
a) evaluating the current status and the set point of the production process using the means for registering input data and monitoring parameters of the production process,
b) cleansing the input data before calculating the sustainability score,
c) solving a multi-objective optimization problem subject for maximizing the utilization factors and minimizing the environmental footprint of the production process, the emissions from processing, by means of manipulating at least one of a plurality of input variables.

10. Computer-implemented monitoring method according to claim 1, further comprising transmitting executable information to the renewables plant via a communication network.

11. Computer-implemented monitoring method according to claim 1, further comprising calculating improved values for one or more underlying variables and reporting the calculated improved values to an operator of the plant.

12. Computer-implemented monitoring method according to claim 1, further comprising:
setpoint tracking and identifying deviations from optimal setpoint in one or more of the manipulated underlying variables causing the observed decrease in utilization factors and/or worsening (as opposite to improving or maintaining) of sustainability score.

13. Computer-implemented monitoring method according to claim 1, further comprising adjusting one or more underlying variables in response to the observed deviations.

14. Computer-implemented monitoring method according to claim 1, wherein the improved values for one or more of the underlying variables are calculated to improve the sustainability score of the production process and/or a utilization factor.

15. Computer-implemented monitoring method according to claim 1, wherein the production process comprises a catalytic reaction step, and the method comprises receiving input data for temperature and pressure in the catalytic reaction step.

16. Computer-implemented monitoring method according to claim 15 wherein the replacement of catalysts is optimized, being scheduled as a result of calculations based on input data.

17. Data-processing system for performing the computer-implemented monitoring method according to claim 1, said data-processing system comprising a server, the server being located distant from the renewables plant and being connected to the internet.

18. Computer-implemented monitoring system for a renewables plant providing a display device for calculating and interactively displaying input data and sustainability scores, the display device being configured for graphically or textually receiving an input signal, using a human-machine interface via a dedicated communication infrastructure, said monitoring system comprising:
the means for registering input data;
the data-processing system according to claim 17,
wherein said system is coupled to a server for communicating with a plant via a communication network, using a web-based platform for receiving and/or sending input data over the network.

19. Computer-implemented monitoring system for a renewables plant according to claim 18, wherein said means for registering input data are a plurality of sensors located at the renewables plant, configured for transmitting sensor data to the server via the internet.

20. Computer-implemented monitoring system for a renewables plant according to claim 19, wherein said plurality of sensors monitor the same or different underlying variables or parameters of the production process.

21. Computer-implemented monitoring system for a renewables plant according to claim 18, wherein said plurality of sensors are located along a reactor to collect data from different positions in the same location of the equipment.

22. Plant for production of a chemical or fuel product, at least partly from a renewable feedstock or source, the plant comprising a data processing system according to claim 17, the plant comprising the means for registering input data and being arranged such that:
a) input data indicative of a measure of at least a material input to the production process, a production energy consumption, and a utilization factor are received,
b) a sustainability score from the received input data is calculated.

23. Plant according to claim 22, wherein the means for registering input data are one or more sensors.

24. Plant according to claim 22 wherein said plant is arranged for production of a chemical or fuel product via hydroprocessing, hydrogen production, ammonia production or production of methanol, ethanol, naphtha, synthesis gas, jet fuel, diesel, from renewable feedstocks or sources, including e-chemicals and e-fuels.

25. Computer-implemented method of controlling production of a chemical or fuel product by a renewables plant at least partly from a renewable feedstock or source, the plant comprising means for registering input data, the method comprising:
a) at a predetermined measuring interval, or continuously, receiving input data obtained from the means for registering input data and indicative of a measure of at least a material input to the production process, a production energy consumption, and a utilization factor;
b) at a predetermined calculating interval, or continuously, calculating a sustainability score from the received input data;
c) determining a deviation in the sustainability score;
d) determining an underlying variable as a cause of the deviation; and
e) changing the underlying variable to obtain a target sustainability score.

26. Computer-implemented system for controlling production of a chemical or fuel product by a renewables plant at least partly from a renewable feedstock or source, the plant comprising means for registering input data, the system being configured for:
a) at a predetermined measuring interval, or continuously, receiving input data obtained from the means for registering input data and indicative of a measure of at least a material input to the production process, a production energy consumption, and a utilization factor,
b) at a predetermined calculating interval, or continuously, calculating a sustainability score from the received input data;
c) determining a deviation in the sustainability score;
d) determining an underlying variable as a cause of the deviation; and
e) changing the underlying variable to obtain a target sustainability score.
